(19) United States
(12) Patent Application Publication
(10) Pub. No.: US 2004/0144827 A1
(43) Pub. Date: Jul. 29, 2004

(54) Uni-directional wire advancing and holding device

(76) Inventor: Ted Fox, Warren, PA (US)

Correspondence Address: Kenneth W. Wargo, Esq., 2222 West Grandview Boulevard, Erie, PA, 16506, US

(21) Appl. No.: 10/350,674

(22) Filed: Jan. 27, 2003

(51) Int. Cl. B65H 23/06; B23B 5/22

(52) U.S. Cl. 226/151; 279/30

(57) ABSTRACT

A device that advances and holds wire as the wire is fed through the device and prevents any movement in the opposite or reverse direction by instantly locking on the wire when movement in the reverse or opposite direction is attempted includes a main barrel having a bore through which the wire passes and one or more inserts disposed at the feed end of the main barrel for maintaining the longitudinal orientation of the wire as the wire exits the main barrel. Disposed within the bore is a one-way wire locking or clutch assembly that includes a tapered chamber and a plurality of radially arranged locking balls mounted on a circular head of a stem wherein the locking balls allow wire to freely travel therethrough in the feed direction but interact with the tapered chamber to lock on the wire for preventing any movement in the reverse direction.

### FIELD OF THE INVENTION

The present invention pertains to wire holding and feeding devices, and, more particularly, pertains to a uni-directional wire feeding and holding device that allows the free passage of wire through the device in the feed direction but prevents any movement in the reverse or opposite direction by instantly locking on the wire when such movement is attempted.

### BACKGROUND OF THE INVENTION

The wire forming industry is a multifarious industry whose end products pervade contemporary industrial, technological society. Among the end products of the wire forming industry are the handles for paint rollers, the connecting rods for kitchen sponge mops, the framework or supports for home, retail and commercial shelving, grocery carts, hangers, and the clips used in automotive brakes.

Wire of various gauges is mounted on spindles or spools and is unwound therefrom so that one or multiple operations, such as forming, flattening, bending, punching, and notching, can be performed on the wire as part of the manufacturing process. Generally the current practice is that one or more micro-switches move and manipulate the wire by first grasping the wire, advancing the wire the required distance so that the specific operation can be performed on the appropriate length of the advanced wire, and then releasing the wire after the operation has been performed, whereupon the next length of wire can be advanced under control of the micro-switches so that the appropriate length of wire is presented for the next operation. It is critical for the wire to be firmly and securely held in position during the particular operation so that the wire doesn't retract or withdraw in the reverse or opposite direction from which it was initially fed or advanced. The current practice of using microswitches suffers from many disadvantages. The microswitches must be sequenced and coordinated to a high degree of accuracy to perform effectively. Synchronization of the switches is easily disturbed and proper readjustment is time-consuming and difficult.

The prior art discloses a number of devices for feeding or drawing a wire; representative of the prior art are U.S. Pat. No. 1,017,628; U.S. Pat. No. 2,882,361; U.S. Pat. No. 4,422,583; U.S. Pat. No. 4,696,175; U.S. Pat. No. 4,827,752; and U.S. Pat. No. 5,724,847.

### SUMMARY OF THE INVENTION

The present invention comprehends a purely mechanical device for both feeding and advancing a wire during a manufacturing process, and includes a main barrel having a bore extending therethrough from a feed or ingress end to an opposite egress end, and the main barrel is secured to a platform or framework by, for example, clamps. Disposed within the main barrel at the feed end is one or more inserts with the inserts concentric to and partially telescoped within each other. The inserts support and maintain the longitudinal orientation of the wire as the wire enters the feed end.

Disposed within the main barrel are a number of elements that maintain the wire traveling therethough in its longitudinal disposition and also lock on to the wire to prevent any movement in the direction reverse or opposite of the feed direction. A stepped locking collar having a locking collar bore is disposed within the bore of the main barrel adjacent the egress end and is secured to the main barrel for closing off the egress end and supporting other elements of the device. Disposed within the bore of the main barrel is a one-way wire locking assembly comprising several elements that coact together to allow the wire to freely travel through the main barrel when fed in from one direction—the feed end—but prevent the wire from moving in the reverse or opposite direction—that is from the egress end toward the feed end.

The one-way wire locking assembly includes a stem disposed within the bore of the main barrel. The stem includes a passageway in axial alignment with the bore of the main barrel and through which the wire is fed. The inner end of the stem includes a circular seat or head having three radially arranged channels that register with the passageway and received within each channel is a locking ball. An inner sleeve having a tapered chamber is disposed within the bore of the main barrel, and the tapered chamber of the inner sleeve encompasses the circular head of the stem and the locking balls seated within the channels of the circular head. The taper of the chamber increases toward the egress end of the main barrel.

Thus, wire is fed into the feed end of the main barrel and through the passageway of the stem, and exits the main barrel at the egress end. One or more manufacturing processes or steps are performed on the length of wire that extends from the egress end of the main barrel while the wire is held firmly in position by the device during such manufacturing processes or steps. However, as soon as there is any occurrence or attempt by the wire to move in the reverse or opposite direction—from the egress end toward the feed end—the coaction of the locking balls and the circular head of the stem biased into the tapered end of the inner sleeve causes the locking balls to instantly lock on the wire as they are urged into the narrower taper and thereby prevent any movement of the wire in the direction opposite of that which the wire is being fed.

It is an objective of the present invention to provide a uni-directional wire feeding and holding device that uses mechanical elements that lock on the wire to prevent the wire from moving in a direction opposite or the reverse of the advancing or feed direction.

It is another objective of the present invention to provide a uni-directional wire feeding and holding device that does not require micro-switches to advance the wire and lock on to the wire to prevent movement in the reverse or opposite direction.

It is yet another objective of the present invention to provide a combination of at least two uni-directional wire feeding and holding devices on a platform wherein one device is stationary to hold the wire and the other device is movable thereon to advance the wire.

Yet another objective of the present invention is to provide a uni-directional wire feeding and holding device that securely locks on the wire upon any attempt at movement of the wire in the rearward or opposite direction and whose positive grip on the wire prevents any rearward slippage of the wire.

These and other objects, features and advantages will become apparent to one skilled in the art upon a perusal of the following detailed description when read in conjunction with the accompanying drawings.

### BRIEF DESCRIPTION OF THE DRAWINGS

FIG. 1 is a simplified perspective view of the uni-directional wire feeding and holding device illustrating the mounting of two devices on a platform wherein one device is stationary for holding the wire and one device is movable for advancing the wire;

FIG. 2 is an exploded assembly view of the uni-directional wire feeding and holding device;

FIG. 3 is a sectioned elevational view of the uni-directional wire feeding and holding device showing the initial insertion of the wire into the feed end of the main barrel;

FIG. 4 is a sectioned elevational view of the uni-directional wire feeding and holding device showing the wire contacting the elements of the one-way locking assembly disposed within the bore of the main barrel;

FIG. 5 is a sectioned elevational view of the uni-directional wire feeding and holding device showing the wire passing by the elements of the one-way locking assembly and advancing out of the egress end of the main barrel;

FIG. 6 is a sectioned elevational view of the wire and the elements comprising the one-way locking assembly taken along lines VI-VI of FIG. 3;

FIG. 7 is a sectioned elevational view of the wire and the elements comprising the one-way locking assembly taken along lines VII-VII of FIG. 4;

FIG. 8 is a sectioned elevational view of the wire and the elements comprising the one-way locking assembly taken along lines VIII-VIII of FIG. 5;

FIG. 9 is a sectioned elevational view of the inner tapered sleeve first shown in FIG. 1 and comprising one of the elements of the one-way locking assembly; and

FIG. 10 is a sectioned view of the inner tapered sleeve of FIG. 9 taken along lines X-X of FIG. 9.

### DETAILED DESCRIPTION OF THE PREFERRED EMBODIMENT

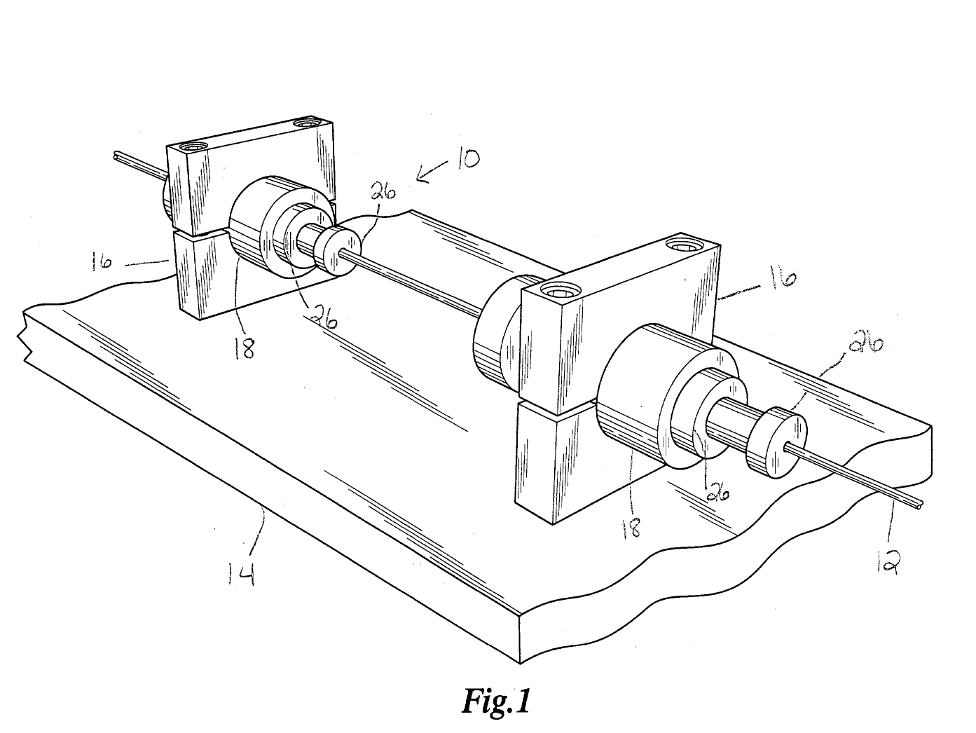

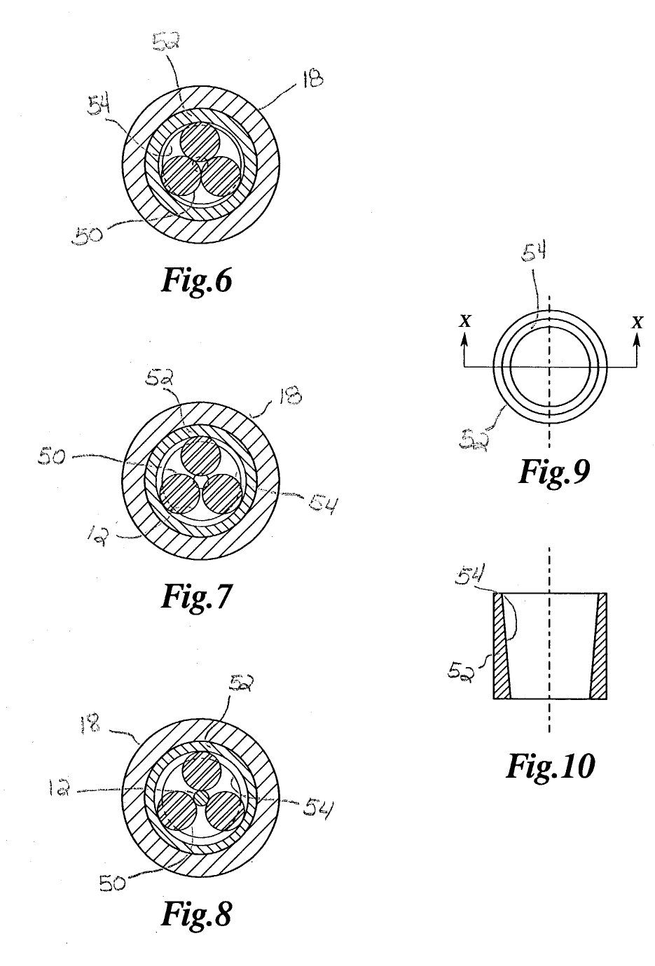

Illustrated in FIGS. 1-10 is a wire feeding, advancing and holding device 10 used in the wire forming industry, and that provides for a uni-directional feed or advancement of successive lengths of the wire 12 for a particular manufacturing operation while holding the wire 12 firmly in position and preventing any movement of the wire 12 in the direction opposite of the direction of feed or advancement.

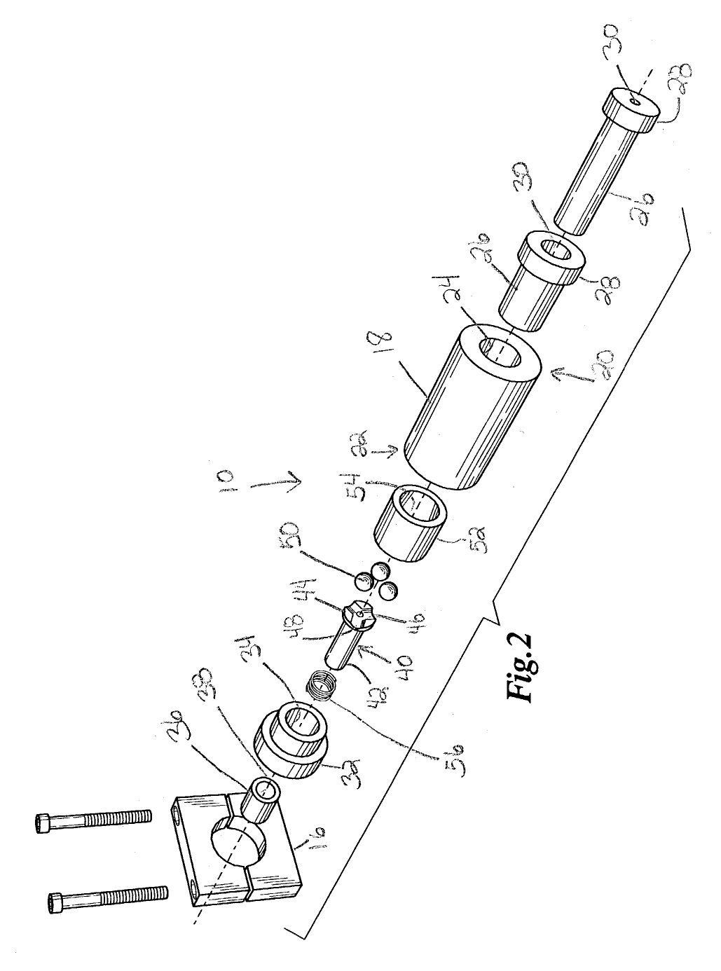

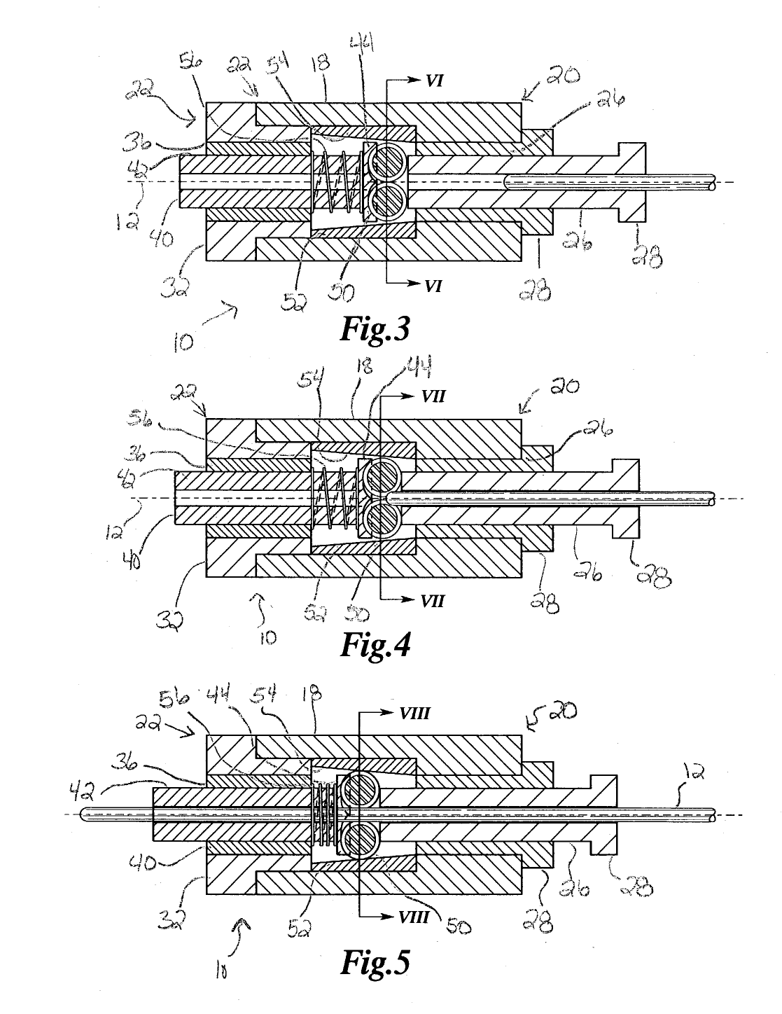

As shown in FIGS. 1 and 2, the device 10 is generally mounted on a table or platform 14 and is secured thereto by clamps 16. FIG. 1 shows two of the devices 10 mounted on the platform 14 in axial alignment with each other. Wire 12 from a spool or spindle (not shown) is fed or advanced through the device 10 in successive stages or sequences so that an appropriate length of wire 12 protrudes from the device 10 that is sufficient for a given manufacturing operation. After this operation is completed another length of the wire 12 is advanced through the device 10 for the next operation. The portion of the wire 12 extending within the device 10 is held fast while the manufacturing operation is occurring, and after completion the wire 12 is temporarily released so that another length of the wire 12 can be fed or advanced through and then out of the device 10 preparatory for the next manufacturing operation. Thus, the wire 12 is first advanced and then held by the device 10 for that particular manufacturing step or operation. With reference to FIG. 1, one device 10 is maintained in a stationary position on the table 14 for holding the wire 14 in position during the manufacturing operation while the other device 10 is movable in a linear reciprocable manner on the table 14 for continually advancing the wire 12 after each respective manufacturing step or operation. Also, with particular reference to FIGS. 3-5, the wire 12 advances and is fed through the device 10 from the right and exits the device 10 on the left.

As shown in FIGS. 1 and 2, the device 10 includes a generally cylindrical main barrel 18 for securement to the clamps 16. The main barrel 18 includes a wire ingress or feed end 20, an opposite egress end 22 and a stepped bore 24 extending therethrough that is coequal in length with the main barrel 18. A pair of mounting holes (not shown) extend through the body of the main barrel 18 adjacent the feed end 20 and the egress end 22. While the body of the main barrel 18 is shown as cylindrical in FIGS. 1 and 2, the main barrel 18 could be square-shaped as long as the body conforms to the clamp dimensions for mounting to the table or platform 14. The inner annular surface defining the stepped bore 24 may include two slots integrally formed thereon and spaced 180 degrees from each other and whose purpose will be hereinafter further described.

As shown in FIGS. 1-5 the device 10 includes at least two inserts 26 disposed within the bore 24 of the main barrel 18 at the feed end 20. Each insert 26 includes an annular flange 28 for seating the insert 26 at the feed end 20 of the main barrel 18 or in abutting relationship with the other insert 26. As best seen in FIG. 2, the inserts 26 include insert bores 30 so that the inserts 26 can be disposed one within another in a partial telescoping or stacked arrangement. The inserts 26 are mounted concentric with the stepped bore 24 of the main barrel 18 and assist in maintaining the longitudinal orientation of the wire 12 as lengths of wire 12 successively pass through the main barrel 18 and exit from the egress end 22 as part of a particular machining operation. Inserts may be changed to accommodate different diameters of wire. Through holes (not shown) in the main barrel 18 and insert 26, together with set screws (not shown) lock the inserts 26 in place.

Illustrated in FIGS. 1-5 is a generally cylindrical, stepped locking collar 32 mounted to the main barrel 18, and partially within the stepped bore 24, at the egress end 22 thereof. The locking collar 32 both closes off the egress end 22 of the main barrel 18 and provides support for elements hereinafter further described. The locking collar 32 includes a locking collar bore 34 that is concentric with the bore 24 of the main barrel 18. A through hole (not shown) in the main barrel 18 adjacent the smaller stepped portion of the locking collar 32 permits a set screw (not shown) to fix the locking collar 32 in place. The larger stepped portion of the locking collar 32 includes a locking collar through-hole (not shown). The purpose of the locking collar through-hole will be hereinafter described.

As shown in FIGS. 1-5, a cylindrical spring seating sleeve 36 is disposed within the locking collar bore 34 of the locking collar 32 and is maintained in position by inserting a set screw (not shown) through the locking collar through-hole and against the spring seating sleeve 36. The spring seating sleeve 36 includes a sleeve bore 38 that is concentric with the bore 24 of the main barrel 18 and the locking collar bore 34 of the locking collar 32. The spring seating sleeve 36 can be linearly adjusted with regard to the depth of its insertion within the bore 34 of the locking collar 32 and its placement relative to the main barrel 18.

The uni-directional wire advancing and holding device 10 of the present invention includes a one-way wire locking assembly that functions somewhat like a one-way clutch and comprises a number of elements mounted within the bore 24 of the main barrel 18; and the assembly is further enclosed within the bore 24 by the inserts 26 disposed at the feed end 20 and the locking collar 32 and spring seating sleeve 36 mounted at the egress end 22 of the main barrel 18. The one-way locking assembly allows the wire 12 to freely advance through the main barrel 18 from the feed direction while preventing any movement of the wire 12 in the reverse or opposite direction by locking on the wire 12 and thereby permitting wire 12 advancement in only one direction.

Disposed within, and partially extending therethrough, the sleeve bore 38 of the spring seating sleeve 36 is a stem 40 having an elongated, cylindrical shank 42 and a circular seat or head 44 integrally attached to the inner end of the shank 42. A passageway 46 extends through the stem 40 and registers with the circular head 44. The shank 42 of the stem 40 is insertably and slidably received within the sleeve bore 38 of the spring seating sleeve 36 and the passageway 46 of the stem 40 is concentric with the bore 24 of the main barrel 18 and sized to allow wire 12 to freely advance and travel therethrough. As shown in FIG. 2, formed on the circular head 44 is a plurality of grooved channels 48 radially arranged thereon and registering with the passageway 46 of the stem 40. In the preferred embodiment three channels 48 are formed on the head 44 with the channels 48 being spaced 120 degrees from each other.

Mounted within each respective channel 48 is a locking ball 50 that can be an appropriately sized ball bearing as illustrated in FIGS. 2-8. The locking balls 50 do not prevent the advancement of the wire 12 through the main barrel 18 as the wire 12 enters the feed end 20 of the main barrel 18 from the feed direction. However, the locking balls 50 cooperate with the circular head 44 and other elements hereinafter further described to prevent any movement of the wire 12 in the direction reverse or opposite to the feed direction by instantly locking on to the wire 12 upon any attempt at movement of the wire 12 in the reverse or opposite direction.

Thus, the one-way locking assembly also includes an inner tapered sleeve 52 disposed within the bore 24 of the main barrel 18, and in the preferred embodiment the inner tapered sleeve 52 is press fitted within the bore 24 of the main barrel 18 by using an elongated tool that cooperates with the spaced slots (not shown) formed on the annular wall of the bore 24 to tap and seat the inner tapered sleeve 52 securely therein. The inner tapered sleeve 52 further defines an interior tapered chamber 54 whose taper increases from the feed end 20 of the main barrel 18 toward the egress end 22 of the main barrel 18. The taper of the chamber 54 is preferably between three degrees and eight degrees, and in the preferred embodiment the taper is five degrees. As shown in FIGS. 3-5, the circular head 44 of the stem 40 and the locking balls 50 are disposed within the interior tapered chamber 54 of the inner sleeve 52 and cooperate therein to prevent the wire 12 from being withdrawn toward the feed end 20 of the main barrel 18. The size of the locking balls 50 and the diameter of the circular head 44 of the stem 40 must be appropriately sized in order to allow for some slight movement of the locking balls 50 within the channels 48 in order to permit the advancement of the wire 12 through the main barrel 18 but prevent the withdrawal of the wire 12 in the opposite direction.

In addition, as shown in FIGS. 2-5, the one-way locking assembly also includes a compression or biasing spring 56 that interacts with the circular head 44 of the stem 40 to facilitate the action of the locking balls 50 contacting and locking the wire 12 in position immediately upon any attempt to withdraw the wire 12 toward the feed end 20 of the main barrel 18. The biasing spring 56 is disposed on and circumjacent the shank 42 of the stem 40 with one end of the biasing spring 56 abutting the inner end of the spring seating sleeve 36 and a second inner end abutting the underside of the circular head 44 and tending to bias the circular head 44 and the locking balls 50 inward toward the decreasing portion of the tapered chamber 54 of the inner tapered sleeve 52. The tension—and force—of the biasing spring 56 directed against the circular head 44 can be adjusted by varying the longitudinal placement of the spring seating sleeve 36 within the locking collar bore 34 where such variation in position confines the biasing spring 56 within either a larger or smaller space defined by the area between the inner end of the of the spring seating sleeve 36 and the underside of the circular head 44 of the stem 40.

Thus, the elements of the one-way locking assembly allow for the feeding and advancement of the wire 12 through the main barrel 18—through the insert bore 30 of the insert 26 and the passageway 46 of the stem 40—so that successive lengths of wire 12 can be drawn from the egress end 22 of the main barrel 18 for a manufacturing operation to be performed thereon. While the length of wire 12 is, for example, being notched, flattened or punched, the wire 12 extending within the main barrel 18 is being held in position as any movement of the wire 12 toward the feed end 20 instantly causes the engagement of the one-way locking assembly to lock on the wire 12 preventing any such rearward movement.

The foregoing description discloses and describes a preferred embodiment of the invention, and those skilled in the art will understand that other variations and modifications are possible and practicable, and still come within the ambit of the invention.

1. A device for holding wire in position during a forming operation, comprising:
a main barrel having a first feed end for receiving the wire, a second egress end, and a bore extending therethrough;
a locking sleeve having an interior tapered chamber and the locking sleeve disposed within the bore of the main barrel at the second egress end;
a stem disposed within the tapered chamber of the locking sleeve and capable of slidable reciprocable movenent therein, the stem having an elongated passageway through which the wire can pass and a circular head having a plurality of channels with the channels radially converging at the passageway;
a spring seating sleeve for disposition about the stem adjacent the second egress end of the main barrel;
a compression spring disposed on the stem and having a first spring end supported on the spring seating sleeve and a second spring end biasing the circular head of the stem for urging the stem into the tapered chamber so that the circular head abuts the tapered chamber as the wire is fed through the main barrel;
a plurality of locking balls with one locking ball disposed within one channel of the circular head, so that the balls converge upon the wire thereby allowing the wire to freely travel through the main barrel; and
as the wire is fed into the first feed end of the main barrel and through the passageway of the stem, there is unimpeded passage of the wire through the main barrel but withdrawal of the wire from the main barrel is prevented by the locking balls locking onto the wire immediately upon the wire being drawn toward the feed end of the main barrel.

2. The device for holding wire in position of claim 1 including at least one insert mounted at the feed end of the main barrel concentric to the bore of the main barrel for maintaining the longitudinal orientation of the wire as the wire is drawn through the feed end and the egress end of the main barrel.

3. The device for holding a wire in position of claim 2 wherein the channels formed on the head of the stem are radial grooves and spaced 120 degrees from each other and register with the passageway of the stem.

4. The device for holding wire in position of claim 3 wherein the locking balls immediately grip and hold the wire if the wire is pulled toward the feed end of the main barrel thereby providing for a uni-directional feed of the wire through the main barrel.

5. The device for holding wire in position of claim 4 wherein two wire holding devices can be mounted in axial alignment on a carriage with one wire holding device being stationary and one wire holding device being movable so that the wire is advanced by the movable wire holding device and prevented from movement in the reverse direction by the stationary wire holding device.

6. The device for holding wire in position of claim 5 wherein the tapered chamber has a taper of between three degrees and eight degrees.

7. A uni-directional wire feeding device through which a wire is fed in one direction and prevented from movement in the opposite direction, comprising:
a main barrel having a bore that extends from a feed end to an egress end and through which the wire is fed;
a locking sleeve disposed within the bore and further defining a tapered interior chamber;
a one-way clutch assembly disposed within the bore of the main barrel for allowing the wire to feed through the main barrel in one direction and immediately gripping the wire when the wire is pulled in the opposite direction thereby preventing movement of the wire in the opposite direction; and
at least one insert disposed in the bore of the main barrel adjacent the feed end for maintaining the longitudinal orientation of the wire as the wire passes through the insert and exits from the egress end of the main barrel.

8. The uni-directional wire feeding device of claim 7 wherein the one-way clutch assembly includes a stem disposed within and concentric to the bore of the main barrel and having an elongated passageway through which the wire can pass.

9. The uni-directional wire feeding device of claim 8 wherein the stem includes a circular head having a plurality of channels formed thereon and radially registering with the passageway.

10. The uni-directional wire feeding device of claim 9 wherein the stem is capable of axial adjustment within the bore of the main barrel.

11. The uni-directional wire feeding device of claim 10 further comprising a spring seating sleeve disposed within the bore of the main barrel adjacent the egress end and capable of adjustable positioning and re-positioning within the bore.

12. The uni-directional wire feeding device of claim 11 wherein the one-way clutch assembly includes a compression spring disposed circumjacent the stem and having a first spring end abutting the spring seating sleeve and a second spring end engaging and biasing the head of the stem toward the tapered interior chamber of the locking sleeve.

13. The uni-directional wire feeding device of claim 12 wherein the clutch assembly includes a plurality of locking balls with one locking ball disposed within each respective channel of the circular head for radially converging toward the passageway of the stem in order to contact the wire as the wire is fed through the barrel and immediately locking onto the wire upon the wire being pulled in the reverse direction thereby preventing any movement of the wire in the reverse direction.

14. The uni-directional wire feeding device of claim 13 wherein two wire feeding devices can be mounted in axial alignment on a carriage with one wire feeding device being stationary and one wire feeding device being movable so that the wire is advanced by the movable wire feeding device and prevented from movement in the reverse direction by the stationary wire feeding device.

15. A uni-directional wire feeding device for allowing wire to freely pass through when being fed from one direction and preventing any movement in the reverse direction by immediately locking on to the wire when any movement in the reverse direction is attempted, the device comprising:
a main barrel having a bore that extends from a feed end to an opposite egress end and through which the wire is fed;
a tapered interior chamber disposed disposed within the bore and wherein the taper increases in the direction of the egress end of the main bore;
a one-way clutch assembly disposed within the tapered interior chamber of the bore for allowing the wire to freely pass through the bore and the tapered interior chamber when the wire is fed through the main barrel from the feed end but preventing any movement of the wire in the opposite direction by locking on to the wire immediately upon any attempt to pull the wire in the opposite direction;
the one-way clutch assembly including a plurality of locking balls that radially converge about the wire letting the wire pass freely through the main barrel from the feed end but preventing any movement of the wire in the opposite direction by instantly locking on to the wire upon any attempt to pull the wire in the opposite direction; and
at least one insert disposed in the bore of the main barrel adjacent the feed end for maintaining the longitudinal orientation of the wire as the wire passes through the insert and exits the main barrel from the egress end.

16. The uni-directional wire locking device of claim 15 wherein the one-way clutch assembly includes a stem disposed within the bore and the tapered interior chamber, the stem having a circular head whereon the locking balls are seated.

17. The uni-directional wire locking device of claim 16 wherein the circular head of the stem includes three radial channels spaced 120 degrees from each other converging about the wire as the wire passes through the stem and each channel maintaining therein one locking ball.

18. The uni-directional wire locking device of claim 17 wherein the interior tapered chamber has a taper of between three and eight degrees.

19. The uni-directional wire locking device of claim 18 wherein two or more inserts can be received within each other in concentric alignment for maintaining the longitudinal orientation of the wire as the wire passes through the inserts and exits the main barrel from the egress end.

20. The uni-directional wire holding device of claim 19 wherein two wire holding devices can be mounted on a carriage in axial alignment to each other whereupon one wire holding device is stationary and one wire holding device is movable on the carriage so that the wire is advanced by the movable wire holding device and prevented from moving in the opposite direction by the stationary wire holding device.
